(19) United States
(12) Patent Application Publication
(10) Pub. No.: US 2017/0026738 A1
(43) Pub. Date: Jan. 26, 2017

(54) Removable and Exchangeable Decoration Tabs and Tags for Earbuds or Earphones

(71) Applicant: Larry Tang, East Brunswick, NJ (US)

(72) Inventor: Larry Tang, East Brunswick, NJ (US)

(21) Appl. No.: 15/202,645

(22) Filed: Jul. 6, 2016

Related U.S. Application Data
(60) Provisional application No. 62/195,827, filed on Jul. 23, 2015.

(51) Int. Cl. H04R 1/10

(52) U.S. Cl. CPC H04R 1/1091; H04R 1/1016

(57) ABSTRACT

A headphone system having an earbud housing, a speaker assembly, and a fastening device to detachably attach exchangeable appliques to an upper chamber of the earbud housing of selected names, pictures, colors or patterns chosen for display purposes by a wearer of the headphone system.

### CROSS-REFERENCE TO RELATED APPLICATIONS

A Provisional Patent Application covering the invention described herein was filed on Jul. 23, 2015, and assigned Ser. No. 62/195,827.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

Field of the Invention

This invention relates to earbud and earphone systems receivable of detachable appliques of selected names, pictures, colors or patterns for display in modifying the appearance of the headphone.

Description of the Related Art

Were a visitor to walk into a sports outdoor stadium or indoor arena during game time, he/she might be taken back by the large number of home town fans there wearing hats, jackets, shirts or blouses bearing the names, colors and/or patterns of their beloved team. In locales where these games are additionally being broadcast, furthermore, the visitor would probably see a great many fans plugged into their smartphones or other electronic devices listening to announcers commenting as to what was going on before them. Multiplying this by all the different home teams in that same city or arena (in the United

States, in Chicago for example, there are the Cubs and the White Sox in Baseball, the Bears in Football, the Bulls in Basketball, and the Blackhawks in Hockey; or in Boston, with the Red Sox in Baseball, the Patriots in Football, the Celtics in Basketball, and the Bruins in Hockey; or in New York, with the Yankees and Mets in Baseball, the Giants and the Jets in Football, the Knicks and Nets in Basketball, and the Rangers, Islanders and Devils in Hockey, the costs for these articles of clothing are not inexpensive. And it goes without saying that the cost for so outfitting a fan's children this way continues to increase with time as the child gets older and thus needs increasingly larger sizes. Going from season sport to season sport, an adult's expenditure for these associations increases as well especially at those times where teams decide to modernize the look of their present uniforms, in changing from one format to another.

### OBJECTS OF THE INVENTION

It is an object of the invention to continue these kinds of display allegiances and fealties to personal headphone systems, but in an inexpensive manner, and not only limited to sports teams affiliations.

### SUMMARY OF THE INVENTION

As will become clear from the following description, the present invention, in one respect, strives to regulate these costs somewhat by providing a removable and exchangeable decorative applique (for example, a tab pr tag) for the earbuds and earphones used with the smartphones or other electronic devices—and, by permitting switching from one team's affiliation and association to anothers' whether in the same sport or not, whether in the same city or not, and whether in the same country or not. Thus, a New York Yankees Baseball fan, residing in Miami, Florida, for example, could switch his earbud or earphone decorative applique to a Dallas Cowboys one for Football, to a Chicago Bulls one in Basketball, to a Los Angeles Kings one for Hockey—and even to a Swedish one for Soccer, and to a New Zealander one for Rugby; or to just trade one for another.

As will be apparent, the removability and exchangability of such applique tab or tag could also be utilized in announcing one's grade school, high school or college name association, another one's affiliated organizational logo, or one's own personal name designation—or just to coordinate with the clothing he or she might be wearing at the time. In these manners, earbuds and earphones could be sold with these individual adornments already in place, along with individual packagings containing different color arrangements, designs, tabs or tags of favorite entertainment world celebrities (such as vocalists, bands, movie stars, and television characters), whatever a buying public might be interested in. A trading of such individual tags or tabs could easily follow between users of correspondingly constructed earbuds or earphones.

### BRIEF DESCRIPTION OF THE DRAWINGS

These and other features of the invention will be more clearly understood from a consideration of the following description, taken in connection with the accompanying Drawings, in which:

FIGS. 1a-1f are line drawings helpful in an understanding of the invention; and

FIGS. 2A-2c are pictorial representations of the construction of an earbud incorporating a removable and exchangeable decorative applique of then type noted above.

### DETAILED DESCRIPTION OF THE INVENTION

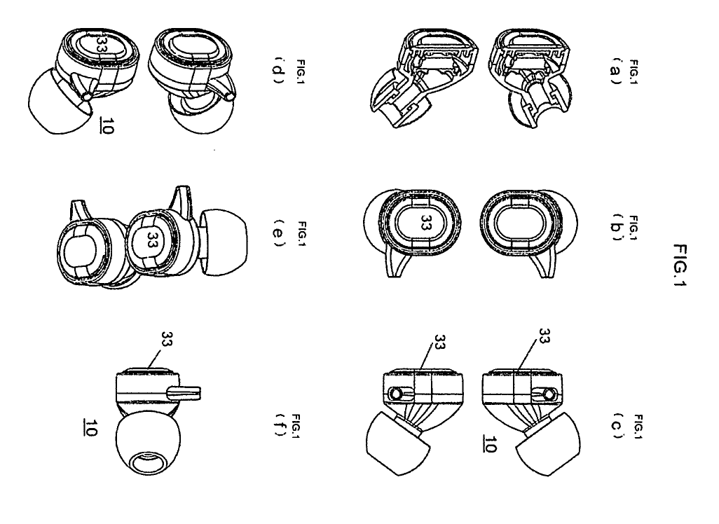

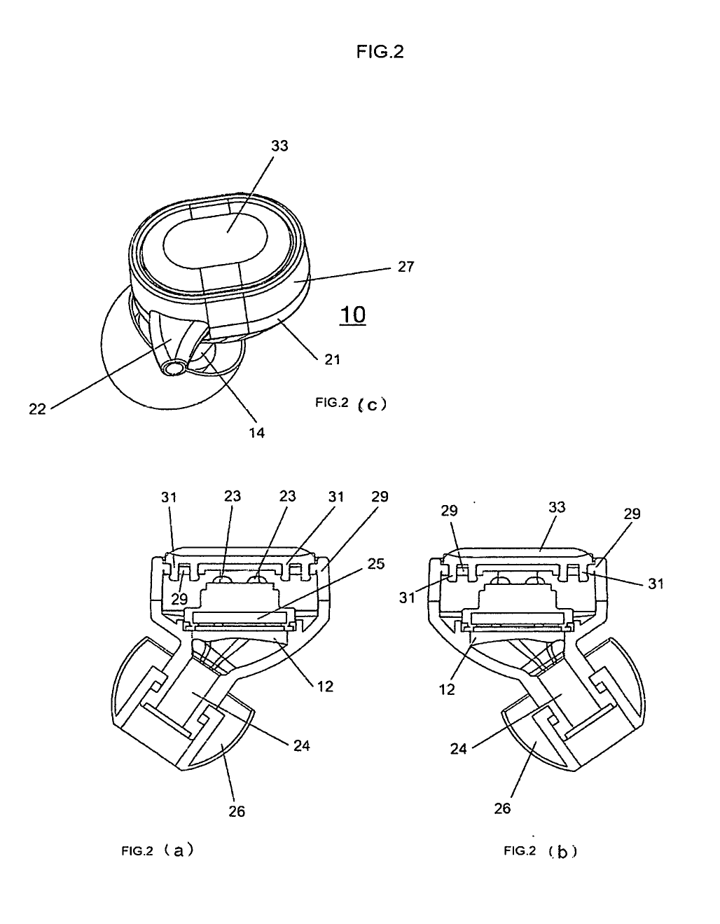

Recognizing that an aim of the present invention is to announce a person's allegiance to one entity or another, or satisfying society's present demands for possessed articles that are unique or personal to one as compared to another, earbuds securable to a user's ears commonly employ a speaker assembly configured to convert an audio signal into a sound wave audible to the human ear, a housing that encloses the speaker assembly, and an extension leading from the housing away from the speaker assembly. Thus, the earbud of the invention is generally shown at 10 in the drawings (FIG. 2c), the speaker assembly is shown at 12 (FIGS. 2a, 2b) and the extension leading from the housing is shown at 14 (FIG. 2c). More particularly, in FIGS. 2a-2c reference numeral 21 identifies a lower chamber of the housing, reference numeral 22 identifies its electrical wire outlet, reference numeral 23 identifies electrical current inlets of the speaker assembly, reference numeral 24 identifies the sound channel of the lower chamber of the earbud housing, reference numeral 25 identifies the diaphragm of the speaker assembly, reference numeral 26 identifies an ear tip (typically of silicone, and reference numeral 27 identifies an upper chamber of the earbud housing. In accordance with the teachings of the invention, (and, further referring to FIGS. 2a-2c), the upper chamber 27 of the earbud housing includes a plurality of cavity components 29 to receive a plurality of leg components 31 of a decorative applique tab or tag 33 so that the tab or tag will stay grasped and affixed with the upper chamber 27—and thus, with the earbud or earphone itself. The applique tab or tag 33 (more clearly shown in FIGS. 2a-2c and in the line drawings of FIGS. 1b-1f) can be if the type previously noted—colorized, or imprinted with any name, team or organizational affiliations, etc. on a top surface, as desired. Understanding that the electrical wire for the earbud housing is welded to the electrical current inlets 23 of the speaker assembly 12, the tab or tag (preferably plastic) can be easily picked out by a user's fingernail or pulled off to allow a different piece to be exchanged and placed into positioned instead. In essence then, the drawings illustrate these removable tabs or tags constructed with “click lock” or “snap lock” press-together-type fastening devices so that the tab or tag could be set in a stable manner within the cavities provided on the earbud housing on the side away from the speaker assembly of the earbud. And, in this manner, the leg components will be seen to extend from a bottom surface of the decorative applique tab or tag 33 to be joined with the cavity components 29 on a top surface of the upper chamber 27 of the earbud housing.

As such, the tabs or tags can serve as a quick premium promotional item for easy accommodation of different logos for a product line to be shipped, as a mood indicator with several different tabs or tags in one package for example, for allowance in doing color matching with a wearer's clothing, or for the team affiliations of the type described above, as well as with other theme activities. As will be readily appreciated, this is of meaningful importance not only where societal emphasis on individuality is of importance as well as where an association with an entity, organization or occupation is of importance.

While what have been described what are considered to be preferred embodiments of the present invention, it will be readily appreciated by those skilled in the art that modifications can be made without departing from the scope of the teachings herein. For at least such reason, therefore, resort should be had to the appended claims for a true understanding of the invention.

I claim:

1. In a headphone system, the combination comprising:
an earbud housing having a lower chamber and an upper chamber;
a speaker assembly configured to convert an audio signal into a sound wave audible to the human ear within said housing;
and a fastening device for the purpose of detachable attachment to said upper chamber, the fastening device embodying a decorative applique of a designated class including name, pictures, colors and/or patterns as selected for display by a wearer of the headphone system.

2. The combination of claim 1 wherein said fastening device detachably attaches to said upper chamber when a bottom surface of said decorative applique and a top surface of said upper chamber are pressed together.

3. The combination of claim 1 wherein said decorative applique is detachable from said upper chamber by pulling or lifting apart said bottom surface of said decorative applique from said top surface of said upper chamber.

4. The combination of claim 1 wherein the appearance of the headphone system is modified as a result of fastening said decorative applique to said top surface of said chamber.

5. The combination of claim 1 wherein said headphone system is aesthetically modified by the addition of said decorative applique.

6. The combination of claim 1 wherein said fastening device embodies an applique of a designated sports team name.

7. The combination of claim 1 wherein said fastening device embodies an applique of a designated sports team logo.

8. The combination of claim 1 wherein said fastening device embodies an applique of a designated entity, organization or school name.

9. The combination of claim 1 wherein said fastening device embodies an applique of a designated entertainment world celebrity.

10. The combination of claim 1 wherein said fastening device embodies a decorative applique on one of a removable and exchangeable pull-off or lift-off surface.

11. The combination of claim 10 wherein said fastening device detachably attaches to said upper chamber when an extending component on a bottom surface of said decorative applique is pressed together with a receiving component on a top surface of said upper chamber of said earbud housing.
